(19) United States
(12) Patent Application Publication
(10) Pub. No.: US 2006/0071023 A1
(43) Pub. Date: Apr. 6, 2006

(54) Device for dispensing a mixed multi-component compound

(75) Inventors: Edgar Lein, Hamburg (DE); Hans Horth, Hamburg (DE)

Correspondence Address: ALIX YALE & RISTAS LLP, 750 MAIN STREET, SUITE 1400, HARTFORD, CT, 06103, US

(73) Assignee: Ernst Muhlbauer GmbH * Co. KG

(21) Appl. No.: 10/539,940

(22) PCT Filed: Dec. 19, 2003
(86) PCT No.: PCT/EP03/14614

§ 371 Date: Jun. 17, 2005

(30) Foreign Application Priority Data
Dec. 19, 2002 (DE) 202 19 752.2

(51) Int. Cl. B67D 5/52

(52) U.S. Cl. 222/135

(57) ABSTRACT

The invention relates to a device for dispensing a mixed multi-component compound from a cartridge. The device has several containers that house the components and a mixing nozzle. The device is characterized in that it comprises a holder for the mixing nozzle that is connected to a holder for the cartridge. The former holder allows the nozzle to be attached to the cartridge.

The invention relates to a device for dispensing a mixed multi-component compound, in particular for dental purposes, from a cartridge with several containers which house the components and from which, in each case by displacement of a plunger arranged therein, the components are pressed out into a mixing nozzle, which is fitted onto the cartridge, and then out of said mixing nozzle, the device comprising a holder for the cartridge.

Devices for dispensing a mixed multi-component compound are known which have a cartridge with several containers which house the components and onto which the mixing nozzle is fitted directly (DE 197 08 548 A1, DE 100 60 513 A1). However, these documents do not provide any details of how the compound is to be pressed out. It may be assumed that a holder is present; but the documents do not contain any details on this matter either. The holder is also only of subordinate importance if it is only liquids of low viscosity that are to be processed, since only slight pressures then arise.

A multi-component cartridge with a replaceable inner package is also known which is expressly intended for liquids (DE 694 15 310 T2). The cartridge is made up of a piston/cylinder unit on which there is secured, inter alia, a component expressly referred to in the document as a cartridge front part 17. This cartridge front part, on which the mixing nozzle is secured, is not a holder for the cartridge, nor can it replace such a holder. Such a holder will presumably be needed when the cartridge is to be used.

To produce dental impressions, dental compounds of relatively high viscosity are used. These are produced by mixing together several components, in particular two components, which are stored in multiple cartridges, in particular double cartridges. A mixer is required for mixing and dispensing the compounds. A device is also needed for pushing the pistons into the cartridges in order to dispense the compounds. The outlet opening of the mixer then dispenses the mixed material advantageously onto a tray used for taking impressions.

For this purpose, the cartridges are inserted into the dispensing unit with their outlet opening pointing downward. To avoid the mixer coming loose during operation, the mixing nozzle is locked onto the cartridge. To do this, the mixer can be held by a bracket to be mounted pivotably on the cartridge, or it can be held via a slide element on the outlet openings of the cartridge (DE 298 20 832 U, DE 299 17 013 A). A cartridge contains material for several applications. Since the material begins to harden immediately after the mixing, a new mixer has to be used for each application. To do this, the cartridge either has to be removed from the unit in order to secure the new mixer in place, or the mixer has to be fitted in place with the cartridge inside the unit, which proves awkward because the cartridge opening is difficult to see since it is facing downward. Another disadvantage is that additional disposable parts (slide elements) are needed for each cartridge, which increases the costs and creates additional waste material.

The object of the invention is to make available a device of the aforementioned type in which the mixing nozzle can be exchanged in a simpler way and more quickly.

The solution according to the invention lies in the fact that the device comprises a holder for the mixing nozzle, which holder is connected to the holder for the cartridge and allows the mixing nozzle to be brought into communication with the cartridge.

Thus, the mixing nozzle is not connected directly to the cartridge. Instead, both are accommodated and held separately in the device. With the holder for the mixing nozzle, the latter can be brought into communication with the cartridge, which means in particular that a substantially tight connection is achieved between the outlet conduits for the components from the containers and the inlet openings of the mixing nozzle. With this holder, the mixing nozzle is held on the device on which the cartridge is also already held. The mixing nozzle can in this case be inserted or removed by appropriate actuation of its holder, without the cartridge having to be removed. Disposable parts in the form of slide elements, as in the prior art, are no longer necessary.

Although this latter feature is particularly advantageous, the invention also includes embodiments in which the mixing nozzle can be exchanged only when the cartridge has first been removed.

The invention can be used particularly advantageously in connection with dynamic mixers. In this case, the device according to the invention expediently comprises a drive mechanism which can be connected to the mixing nozzle designed as a dynamic mixer.

The dynamic mixer can be driven and the components pressed out using the same device.

It is expedient that the mixing nozzle can be inserted and removed transversely with respect to the longitudinal axis of the device. The pressing-out forces act in the longitudinal direction such that the mixing nozzle cannot be forced out of the device by these forces.

The device expediently comprises a stop for limiting the transverse movement of the mixing nozzle. The latter is then pushed in in the transverse direction as far as the stop. The operator can then be certain that the mixing nozzle is located in the correct position, in which it can be brought into communication with the cartridge.

The holder for the mixing nozzle is expediently movable in the longitudinal direction of the device, in other words can be moved toward the outlet conduits and, if appropriate, the drive shaft for the dynamic mixer.

The mixing nozzle can be secured on, and released from, the cartridge particularly quickly, easily and reliably when the holder for the mixing nozzle is adjustable with the aid of a lever.

The mixing nozzle has inlet openings for the components, which inlet openings have to be oriented at the correct angle with the outlet conduits for the components from the containers of the cartridge. In an advantageous embodiment, this is achieved by the fact that the holder for the mixing nozzle has two projections onto which it is possible to push the foot part of the mixing nozzle, having grooves arranged diametrically therein. The projections can in this case have different thicknesses, and the grooves corresponding widths, to ensure that the mixer does not twist axially through 180°, that is to say can be inserted only in one position. This is particularly advantageous if the outlet conduits and, correspondingly, the inlet openings have different diameters.

Although cartridges and mixing nozzles are of course parts that can be detached from the actual device, the invention is also intended to include a device which comprises a cartridge and a mixing nozzle.

The scope of protection of the utility model is also intended to cover arrangements of cartridges and mixing nozzles which can be inserted into a device according to the invention.

The invention is described in more detail below on the basis of an advantageous embodiment and with reference to the attached drawings, in which:

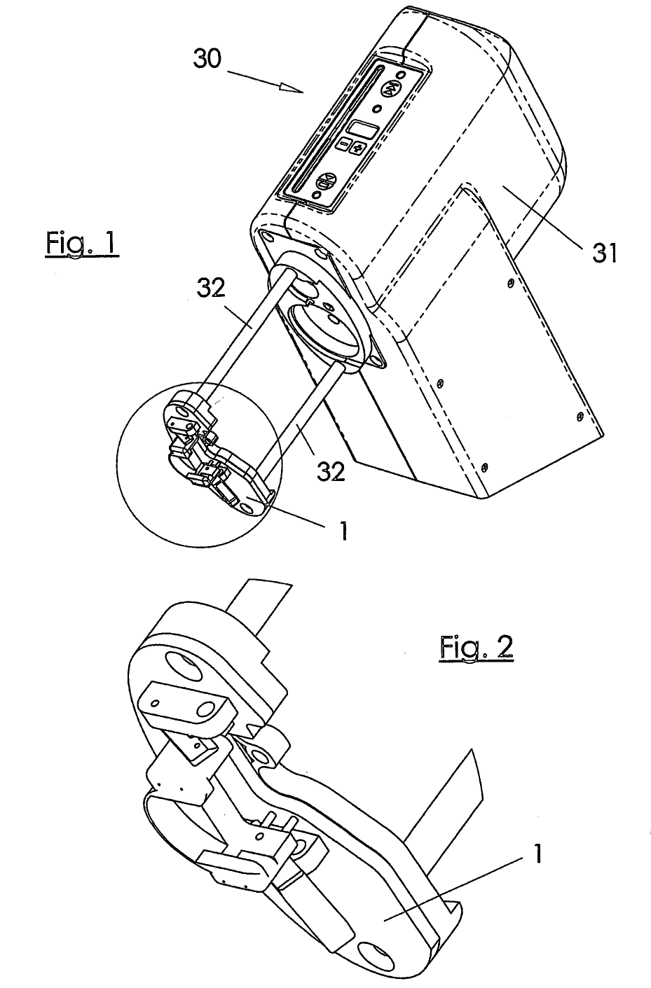

FIG. 1 shows a perspective view of a device according to the invention;

FIG. 2 shows a detailed view of the part of the holder circled in FIG. 1;

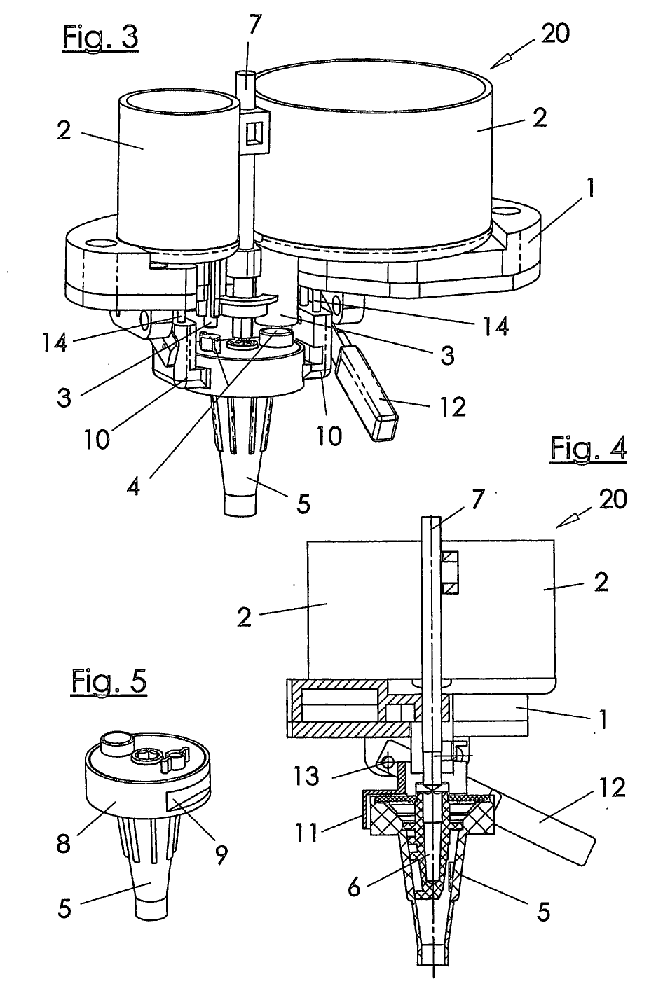

FIG. 3 shows a perspective detailed view of a device according to the invention, with a mixing nozzle inserted but not yet fixed;

FIG. 4 shows the arrangement from FIGS. 1 to 3 partially in section;

FIG. 5 shows a perspective view of a mixing nozzle;

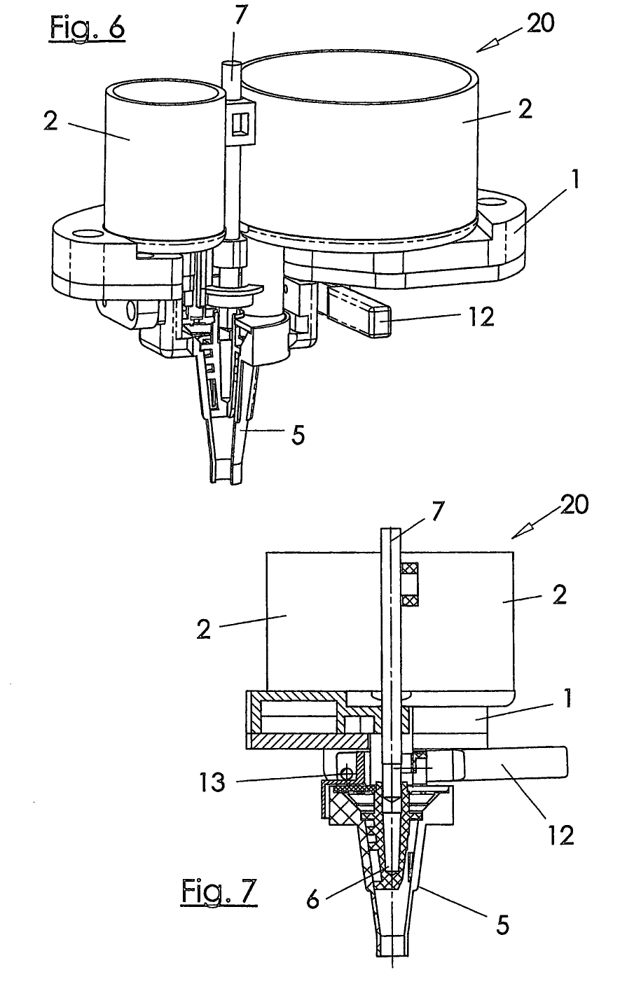

FIG. 6 shows a perspective detailed view of the device, with the mixing nozzle (shown partially in section) inserted and also fixed; and

FIG. 7 shows the arrangement from FIG. 6 partially in section.

A device 30 according to the invention is shown in FIG. 1, having a main part/drive part 31 with which the plunger can be driven, and having a base plate 1. The base plate in FIG. 1 is shown on an enlarged scale in FIG. 2. The cartridges are clamped between the main part 31 of the device and the base plate 1. For this purpose, the base plate 1 is held by rods 32.

FIGS. 3, 4, 6 and 7 show a detailed view of the device according to the invention. The cartridge 20 with its containers 2 is fitted on a base plate 1. Only the lower part of the containers 2 is shown, and one has to imagine these containers continuing upward. A plunger (not shown) is arranged in each of the containers 2 and can be forced downward by devices (also not shown) arranged above the containers 2, so that the components can emerge through outlet tubes 3 and pass into inlet openings 4 of a mixing nozzle 5, in order thereafter to be pressed out of said mixing nozzle 5. The mixing nozzle 5 in this case comprises a mixing mill 6 which can be driven by a shaft 7.

As is shown in FIG. 5, the mixing nozzle 5 is provided, at two diametrically opposite locations of its foot part 8, with mutually parallel grooves 9, of which only one is shown in FIG. 5. With these grooves 9, the mixing nozzle 5 is guided on two rails 10 of the device when the mixing nozzle 5 is pushed into the device. This pushing-in in the transverse direction is limited by a stop 11. The rails 10, which hold the mixing nozzle 5, can now be moved upward with the aid of a lever 12 which is mounted at 13 on a corresponding projection of the main part 1. For this purpose, the lever 12 is also connected pivotably to the movable part that includes the rails 10. These rails in turn are held in the axial direction by parallel guides, which are indicated at 14.

After the mixing nozzle 5 has been pushed into the device in the manner shown in FIGS. 3 and 4, the lever 12 is moved upward so that, as is shown in FIGS. 6 and 7, the mixing nozzle 5 is connected with its openings 4 to the outlet tubes 3 of the components and is reliably secured there. At the same time, the mixing mill 6 comes into contact with the shaft 7 and can therefore be driven by the shaft 7.

If the mixing nozzle 5 is to be removed, the lever 12 is moved downward, and the mixing nozzle 5 is pulled out sideways.

Because of the guide provided by the grooves 9 and rails 10, and because the corresponding area of the device can be clearly seen, insertion and removal do not cause any problems. The lateral insertion and removal in the transverse direction is also not impeded by the outlet tubes 3 and shaft 7. These parts make reliable contact with the corresponding parts of the mixing nozzle 5 only when the lever 12 and thus also the mixing nozzle 5 are moved upward in the direction of the cartridge with its containers 2.

1. A device for dispensing a mixed multi-component compound, in particular for dental purposes, from a cartridge with several containers which house the components and from which, in each case by displacement of a plunger arranged therein, the components are pressed out into a mixing nozzle, which is fitted onto the cartridge, and then out of said mixing nozzle, the device comprising a holder for the cartridge and a holder for the mixing nozzle, characterized in that the holder for the mixing nozzle, is connected to the holder for the cartridge via an axial parallel guide, in that the mixing nozzle is not directly connected to the containers, can be accommodated and held separately in the device and allows in that the mixing nozzle by actuation of the holder, can to be brought into and released from a substantially tight engagement with the containers.

2. The device as claimed in claim 1, characterized in that it comprises a cartridge with two containers.

3. The device as claimed in claim 1, characterized in that it is configured in such a way that the mixing nozzle can be replaced without removing the cartridge from the device.

4. The device as claimed in claim 1, characterized in that it comprises a drive mechanism which can be connected to the mixing nozzle designed as a dynamic mixer.

5. The device as claimed in claim 1, characterized in that the mixing nozzle can be inserted and removed transversely with respect to the longitudinal axis of the device.

6. The device as claimed in claim 5, characterized in that it comprises a stop for limiting the transverse movement.

7. The device as claimed in claim 1, characterized in that the holder for the mixing nozzle is movable in the longitudinal direction of the device.

8. The device as claimed in claim 7, characterized in that the holder for the mixing nozzle is adjustable with the aid of a lever.

9. The device as claimed in claim 1, characterized in that the holder for the mixing nozzle has two projections onto which it is possible to push the foot part (8) of the mixing nozzle, having grooves arranged diametrically therein.

10. The device as claimed in claim 9, characterized in that the two projections and, accordingly, the two grooves have different thicknesses and widths, respectively.

11. The device as claimed in claim 1, characterized in that it comprises a cartridge and a mixing nozzle.

12. An arrangement comprising of a cartridge and of a mixing nozzle, characterized in that it can be inserted into a device as claimed in claim 1.

13. The device as claimed in claim 2, characterized in that it is configured in such a way that the mixing nozzle can be replaced without removing the cartridge from the device.

14. The device as claimed in claim 2, characterized in that it comprises a drive mechanism which can be connected to the mixing nozzle designed as a dynamic mixer.

15. The device as claimed in claim 3, characterized in that it comprises a drive mechanism which can be connected to the mixing nozzle designed as a dynamic mixer.

16. The device as claimed in claim 2, characterized in that the mixing nozzle can be inserted and removed transversely with respect to the longitudinal axis of the device.

17. The device as claimed in claim 3, characterized in that the mixing nozzle can be inserted and removed transversely with respect to the longitudinal axis of the device.

18. The device as claimed in claim 4, characterized in that the mixing nozzle can be inserted and removed transversely with respect to the longitudinal axis of the device.

19. The device as claimed in claim 2, characterized in that the holder for the mixing nozzle is movable in the longitudinal direction of the device.

20. The device as claimed in claim 3, characterized in that the holder for the mixing nozzle is movable in the longitudinal direction of the device.
